(19) United States
(12) Patent Application Publication
(10) Pub. No.: US 2023/0400703 A1
(43) Pub. Date: Dec. 14, 2023

(54) IMAGE STABILIZATION MODULE AND CAMERA MODULE INCLUDING THE SAME

(71) Applicant: SAMSUNG ELECTRO-MECHANICS CO., LTD., Suwon-si (KR)

(72) Inventors: Jae Won JUNG, Suwon-si (KR); Namki PARK, Suwon-si (KR); Youngbok YOON, Suwon-si (KR); Jaekyung KIM, Suwon-si (KR); Hongjoo LEE, Suwon-si (KR); Jibuem CHUN, Suwon-si (KR)

(73) Assignee: SAMSUNG ELECTRO-MECHANICS CO., LTD., Suwon-si (KR)

(21) Appl. No.: 18/328,158

(22) Filed: Jun. 2, 2023

(30) Foreign Application Priority Data
Jun. 8, 2022 (KR) 10-2022-0069689
Mar. 22, 2023 (KR) 10-2023-0037239

(51) Int. Cl. G02B 27/64; G03B 5/00

(52) U.S. Cl. CPC G02B 27/646; G03B 5/00; G03B 2205/0007

(57) ABSTRACT

An optical image stabilization module is provided. The optical image stabilization module includes a housing having an inner space; a moving holder that is equipped with a reflective member configured to receive light incident from the outside and change a path of the received light to transmit light having the changed path along an optical axis direction, and is accommodated in the inner space; a guide member that includes a pivot plate interposed between an inner wall of the housing and the moving holder and a support arm protruding from the pivot plate to extend along the optical axis direction; and a rolling member disposed at one end of the support arm.

### CROSS-REFERENCE TO RELATED APPLICATIONS

This application claims the benefit under 35 USC § 119(a) of Korean Patent Application No. 10-2022-0069689, filed on Jun. 8, 2022, in the Korean Intellectual Property Office, and Korean Patent Application No. 10-2023-0037239, filed on Mar. 22, 2023, in the Korean Intellectual Property Office, the entire disclosures of which are incorporated herein by reference for all purposes.

### BACKGROUND

### 1. Field

The following description relates to an image stabilization module and a camera module including the same.

### 2. Description of Related Art

In view of the recent developments in information and communication technology, semiconductor technology, and the like, the use of electronic devices has increased. The electronic device may provide various operations by convergence, rather than by maintaining in its traditional unique region.

A portable electronic device such as, but not limited to, a smartphone, a tablet personal computer (PC), a laptop computer, or the like is now basically equipped with a camera, and the camera may include an autofocus (AF) operation, an optical image stabilizer (OIS) operation, a zoom operation, or the like.

Cameras that are equipped with a high magnification zoom, such as a folded zoom camera or an ultra-high-pixel camera, may be implemented in mobile devices. Additionally, a plurality of camera modules may be implemented in a single mobile device. Accordingly, the application range of the camera may be expanded from an expensive high-end mobile device to a low and middle-priced product.

However, when the camera implemented with the high magnification zoom is used or a plurality of cameras is used, the power consumption of the camera may increase. Accordingly, it is beneficial to implement a camera module that minimizes power consumption.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, an optical image stabilization module includes a housing having an inner space; a moving holder, accommodated in the inner space, and including a reflective member configured to receive light incident from outside, change a path of the received light, and transmit the light along an optical axis direction; a guide member including a pivot plate interposed between an inner wall of the housing and the moving holder and support arms that protrude from the pivot plate to extend along the optical axis direction; and a first rolling member disposed at one end of the support arms.

The moving holder may include a support surface at which the reflective member may be seated to correspond to a reflective surface of the reflective member, and the support arms are extended to be disposed below the support surface.

The support arms may include a pair of support arms, and the pair of support arms may be spaced apart from each other along a first axis that is perpendicular to the optical axis direction and perpendicular to an incident direction of the light.

The first rolling member may include a pair of first rolling members, and the pair of first rolling members may be disposed at a first side and a second side of the reflective member in a direction of the first axis perpendicular to the optical axis direction.

The moving holder may be an accommodating space that is an empty inner space and may accommodate the support arms, an inner wall forming the accommodating space has a pair of seating grooves in which the first rolling member is at least partially accommodated, and the pair of seating grooves are spaced apart from each other along the first axis perpendicular to the optical axis direction.

A distance between centers of the pair of seating grooves of the moving holder may be smaller than a size of a width of the reflective member in a direction of the first axis perpendicular to the optical axis direction.

A distance between centers of the pair of seating grooves of the moving holder may be greater than a size of a width of the reflective member in a direction of the first axis perpendicular to the optical axis direction.

The optical image stabilization module may further include mass blocks that may be disposed between the pair of support arms within the accommodating space, and are fixed to the moving holder.

The first rolling member disposed at a first end of the pair of support arms may include a plurality of first ball units arranged along the first axis perpendicular to the optical axis direction.

A second rolling member may be disposed between the pivot plate and an inner surface of the housing, and the second rolling member may include a plurality of ball units disposed along a second axis parallel to the incident direction of light.

In a general aspect, a camera module includes a housing having an inner space; an optical image stabilization module, accommodated in the inner space, and movably supported at an inner wall of the housing, and including a reflective member configured to receive light incident from outside, change a path of the received light, and transmit the light along an optical axis direction; and a lens module that includes a lens barrel including a plurality of lenses disposed in the optical axis direction so that light reflected by the reflective member passes through the lens barrel, wherein the image stabilization module comprises: a guide member including a pivot plate interposed between the inner wall of the housing and the moving holder, and support arms that protrude from the pivot plate to extend along the optical axis direction; and a first rolling member disposed at one end of the support arm.

The moving holder may include a support surface at which the reflective member may be seated to correspond to a reflective surface of the reflective member, and the support arms are extended to be disposed below the support surface.

The support arms may include a pair of support arms, and the pair of support arms may be spaced apart from each other along a first axis that is perpendicular to the optical axis direction and perpendicular to an incident direction of the light.

The first rolling member includes a pair of first rolling members, and the pair of first rolling members are disposed at a first side and a second side of the reflective member in a direction of the first axis perpendicular to the optical axis direction.

The moving holder has an accommodating space that is an empty inner space and accommodates the support arms, an inner wall forming the accommodating space has a pair of seating grooves in which the first rolling member is at least partially accommodated, and the pair of seating grooves are spaced apart from each other along the first axis.

The camera module may further include mass blocks that may be disposed between the pair of support arms within the accommodating space to be fixed to the moving holder.

In a general aspect, an electronic device includes a folded module including a moving holder, including a reflective member, and configured to rotate around an axis perpendicular to an optical axis direction; a guide member configured to support the moving holder, and including a pivot plate and support arms protruding from the pivot plate, and configured to extend toward the moving holder; and rolling members disposed on one end of the support arms between the support arms and the moving holder.

The support arms and the rolling members may be spaced apart in a direction perpendicular to the optical axis direction.

The rolling members may be disposed at a center of gravity of the moving holder at a lower end of the reflective member.

Other features and aspects will be apparent from the following detailed description, the drawings, and the claims.

### BRIEF DESCRIPTION OF DRAWINGS

FIG. 1 is a perspective view illustrating an example camera module, in accordance with one or more embodiments.

FIG. 2 is an exploded perspective view shown by disassembling the camera module shown in FIG. 1, in accordance with one or more embodiments.

FIG. 3 is a partially exploded perspective view illustrating a folded module excluding a housing from an image stabilization module shown in FIG. 1.

FIG. 4 is a cross-sectional view taken along a line IV-IV′ of FIG. 3.

FIG. 5 is a cross-sectional view taken along a line V-V′ of FIG. 1.

FIG. 6 is a partially exploded perspective view illustrating an example image stabilization module without the housing, in accordance with one or more embodiments.

FIG. 7 illustrates a cross-sectional view of the example image stabilization module shown in FIG. 6 taken in the same manner as in FIG. 4.

FIG. 8 illustrates a cross-sectional view of the example image stabilization module shown in FIG. 6 taken in the same manner as in FIG. 5.

FIG. 9 is a partially exploded perspective view illustrating an example image stabilization module without the housing, in accordance with one or more embodiments.

FIG. 10 illustrates a cross-sectional view of the example image stabilization module shown in FIG. 9 taken in the same manner as in FIG. 5.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

Further, throughout the specification, the phrase “on a plane” means viewing a target portion from the top, and the phrase “on a cross-section” means viewing a cross-section formed by perpendicularly cutting a target portion from the side.

One or more examples may provide an image stabilization module that reduces power consumption by minimizing a rotational moment generated by a weight of a part and reduces driving force, and a camera module including the same.

In an example, rotational moment due to gravity may be minimized by disposing a position of a rotation axis of a moving holder equipped with a reflective member close to a center of gravity within the image stabilization module of a folded module.

In an example, the driving force necessary to generate the same rotational moment may be reduced as positions of a magnet and a coil that are a generating position of a rotational driving force are spaced apart from the rotation axis, and thus power consumption for driving may be reduced.

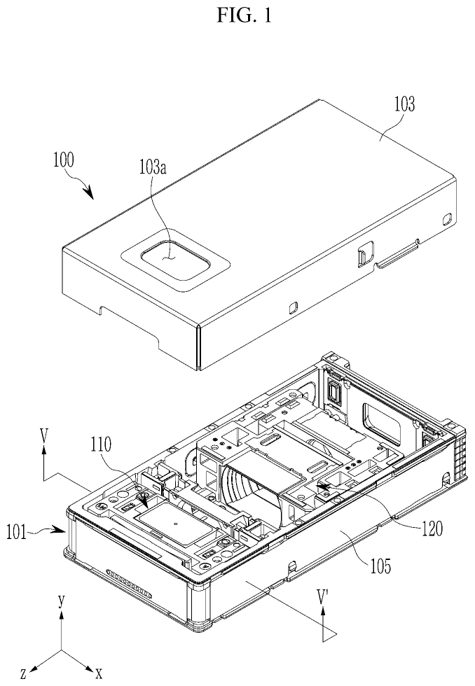

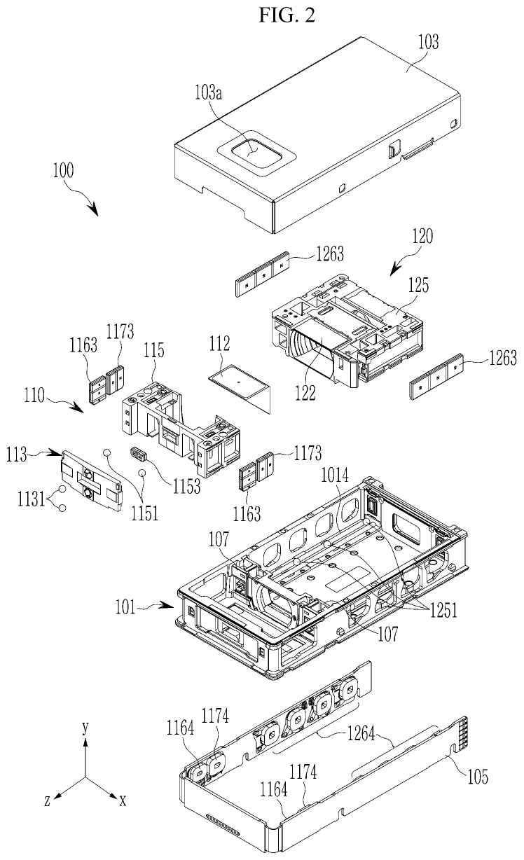

FIG. 1 is a perspective view illustrating an example camera module, in accordance with one or more embodiments, and FIG. 2 illustrates an exploded perspective view of the disassembled camera module illustrated in FIG. 1.

Referring to FIGS. 1 and 2, the example camera module 100, in accordance with one or more embodiments may include a folded module 110 and a lens module 120. The folded module 110 and the lens module 120 may be accommodated in an inner space of a housing 101. A cover 103 partially surrounds an upper portion and a side surface of the housing 101 to constitute a portion of an appearance of the camera module 100.

The folded module 110 may be configured to change a path of light incident from the outside. Light entering the camera module through an opening 103a of the cover 103 may be reflected toward the lens module 120 by the folded module 110.

The folded module 110 may include a moving holder 115 to which a reflective member 112 is mounted, and in an example, the reflective member 112 may be provided in a form of a prism or a mirror. The moving holder 115 may be closely supported on an inner wall surface of the housing 101 by an attractive force between a pulling yoke provided on the inner wall surface of the housing 101 and a pulling magnet 1153 provided at the moving holder 115.

A guide member 113 may be disposed between the inner wall surface of the housing 101 and the moving holder 115. First rolling members 1151 may be interposed between the guide member 113 and the moving holder 115, and second rolling members 1131 may be interposed between the housing 101 and the guide member 113. The first rolling member 1151, the guide member 113, and the second rolling member 1131 may be supported around a pivot axis when the moving holder 115 moves inside the housing 101.

The lens module 120 may be provided to be movable in an optical axis direction in an inner space of the housing 101. The lens module 120 may be configured by coupling a lens barrel 122, having at least one lens therein, to a lens holder 125. Light reflected from the folded module 110 may be refracted while passing through the lens barrel 122. When the lens barrel 122 includes a plurality of lenses, the plurality of lenses may be arranged in the optical axis direction.

Light passing through the lens barrel 122 may be transferred to an image sensor module (not shown) disposed at a rear side of the lens module 120 to be converted to an electrical image signal. The image sensor module may include a circuit board on which an image sensor is mounted. An image may be formed on an imaging surface of the image sensor, the image sensor may generate an image signal for the formed image in response to the image, and the image signal may be transferred to an external circuit through the circuit board. The image sensor module may further include an infrared blocking filter that filters an infrared ray incident from the lens module 120.

The example camera module 100, in accordance with one or more embodiments, may provide, as only examples, an autofocus (AF) operation and an optical image stabilization (OIS) operation.

A focal length of the lens module 120 may be adjusted while the lens module 120 reciprocates along an optical axis. An AF driving portion (or an AF driving part) may be disposed at a side portion of the lens module 120. An AF driving magnet 1263 may be mounted on the lens module 120, and an AF driving coil 1264 may be disposed at a position opposite to the AF driving magnet 1263. The lens module 120 may move along the optical axis due to electromagnetic interaction between the AF driving coil 1264 and the AF driving magnet 1263. In an example, the AF driving coil 1264 may be mounted on a circuit board 105 attached to the housing 101, and the housing 101 may have an opening so that the AF driving coil 1264 and the AF driving magnet 1263 face each other. The circuit board 105 may include a flexible printed circuit board (FPCB).

For smooth driving, ball members 1251 may be disposed between the lens module 120 and an inner bottom surface of the housing 101. The lens module 120 and the inner bottom surface of the housing 101 may include guide grooves 1014 accommodating portions of the ball members 1251. The guide grooves 1014 extend in parallel to the optical axis, and a movement direction of the ball members 1251 is limited to an extension direction (i.e., the optical axis direction) of the guide groove 1014.

The optical image stabilization (015) operation (that is, a shaking correction operation) may be implemented as the folded module 110 rotates about an axis perpendicular to the optical axis within the housing 101. Accordingly, the folded module 110 may be mounted within the housing 101 to constitute the image stabilization module.

The folded module 110 may include an OIS driving portion (or an OIS driving part) configured to rotate the reflective member 112 with respect to the housing 101 about the axis perpendicular to the optical axis. The OIS driving portion may include a first OIS driving portion configured to rotate the reflective member 112 about a first axis perpendicular to the optical axis and a second OIS driving portion configured to rotate the reflective member 112 about a second axis that is perpendicular to the optical axis and intersects the first axis. In this example, the first axis is perpendicular to the optical axis and an incident direction of light incident from the outside, and the second axis is an axis parallel to the incident direction of light. Accordingly, the optical axis may be parallel to a z-axis in the drawings, the first axis may be parallel to an x-axis in the drawings, and the second axis may be parallel to a y-axis in the drawings.

The OIS driving portion may rotate the reflective member 112 about the first axis and/or the second axis so that shaking of an image formed on the image sensor due to shaking of the camera module 100 is optically corrected. Accordingly, the OIS driving portion may generate a driving force so that the moving holder 115 is rotatable about two axes.

The OIS driving portion includes a plurality of OIS driving magnets 1163 and 1173 and a plurality of OIS driving coils 1164 and 1174 disposed to face the plurality of OIS driving magnets 1163 and 1173. When electrical power is applied to the plurality of OIS driving coils 1164 and 1174, the moving holder 115 at which the plurality of OIS driving magnets 1163 and 1173 are mounted may be rotated about the first axis and/or the second axis due to electromagnetic interaction between the plurality of OIS driving magnets 1163 and 1173 and the plurality of OIS driving coils 1164 and 1174.

In an example, the first OIS driving portion may include the first OIS driving magnet 1163 and the first OIS driving coil 1164 to rotate the moving holder 115 about the first axis. When a current is applied to the first OIS driving coil 1164, a Lorentz force may act by a magnetic field of the first OIS driving magnet 1163 corresponding to the first OIS driving coil 1164 so that a rotational moment may be generated with the first rolling member 1151 as a pivot center. The second OIS driving portion may include the second OIS driving magnet 1173 and the second OIS driving coil 1174 to rotate the moving holder 115 about the second axis. When a current is applied to the second OIS driving coil 1174, a Lorentz force may act by a magnetic field of the second OIS driving magnet 1173 corresponding to the second OIS driving coil 1174 so that a rotational moment may be generated with the second rolling member 1131 as a pivot center.

The plurality of OIS driving magnets 1163 and 1173 may be mounted on either surface of the moving holder 115. In this example, the first OIS driving magnet 1163 may be disposed closer to the guide member 113 than the second OIS driving magnet 1173. That is, the first OIS driving magnet 1163 may be disposed closer to a sidewall of the housing 101 to which the guide member 113 is fixed than the second OIS driving magnet 1173.

The plurality of OIS driving coils 1164 and 1174 are mounted on the housing 101. For example, the plurality of OIS driving coils 1164 and 1174 may be mounted on the housing 101 via the circuit board 105. That is, the plurality of OIS driving coils 1164 and 1174 may be provided on the circuit board 105, and the circuit board 105 may be mounted on the housing 101. In the drawings, the circuit board 105 illustrates an example in which a coil for the folded module 110 and a coil for the lens module 120 are integrally provided to be all mounted. However, this is only an example, and the circuit board 105 may be provided by being separated into two or more circuit boards so that the coil for the folded module 110 and the coil for the lens module 120 are respectively mounted.

In the inner space of the housing 101, a space in which the folded module 110 is disposed and a space in which the lens module 120 is disposed may be separated from each other by a sidewall protrusion 107. That is, the folded module 110 may be provided at a front side of the sidewall protrusion 107, and the lens module 120 may be provided at a rear side of the sidewall protrusion 107. The sidewall protrusion 107 may be provided in a shape that partially protrudes to an inner space from both inner walls of the housing 101.

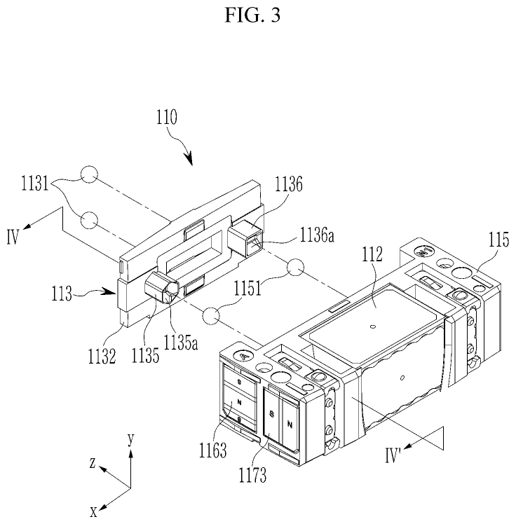

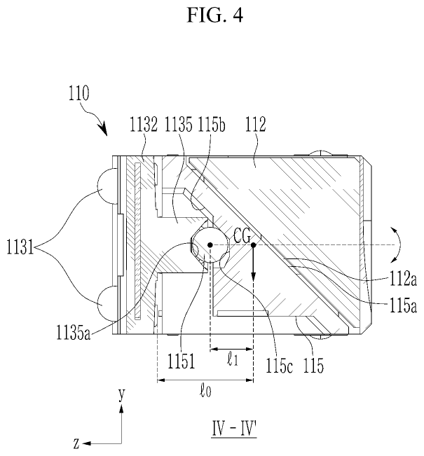

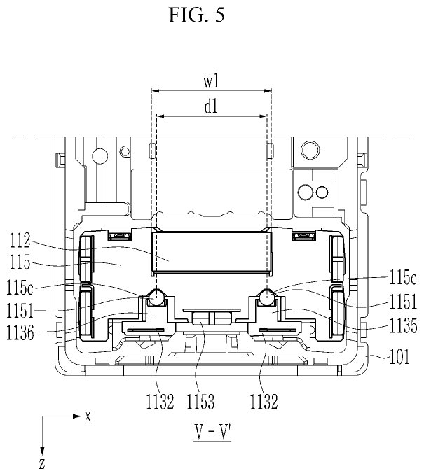

FIG. 3 is a partially exploded perspective view illustrating the folded module excluding the housing from the image stabilization module shown in FIG. 1, FIG. 4 is a cross-sectional view taken along a line IV-IV′ of FIG. 3, and FIG. 5 is a cross-sectional view taken along a line V-V′ of FIG. 1.

Referring to FIG. 3, the folded module 110 constituting the image stabilization module, in accordance with one or more embodiments, includes the moving holder 115 on which the reflective member 112 is mounted, and the guide member 113 that supports the moving holder 115 to be movable with respect to an inner wall of the housing 101 of FIG. 1. The rolling members 1151 and 1131 may be respectively disposed between the moving holder 115 and the guide member 113 and between the guide member 113 and the inner wall of the housing 101.

The guide member 113 may include a pivot plate 1132 and support arms 1135 and 1136 protruding from the pivot plate 1132. The pivot plate 1132 may be interposed between the inner wall of the housing 101 and the moving holder 115, and may have a plate shape having a pair of opposite wide surfaces. The support arms 1135 and 1136 may extend toward the moving holder 115 from one of the wide surfaces of the pivot plate 1132. When a height of the pivot plate 1132 according to an incident direction of light is used as a reference, the support arms 1135 and 1136 may protrude from an intermediate point in a height direction of the pivot plate 1132 to extend along the optical axis direction.

In a non-limited example, the support arms 1135 and 1136 protruding from the pivot plate 1132 may be formed as a pair. The pair of support arms 1135 and 1136 may be spaced apart from each other along the first axis (the x-axis in the drawings) that is perpendicular to the optical axis direction and to the incident direction of light. The first rolling member 1151 disposed at one end of the pair of support arms 1135 and 1136 may include a plurality of ball units disposed along the first axis. The second rolling member 1131 disposed between the pivot plate 1132 and an inner surface of the housing 101 may include a plurality of ball units disposed along the second axis (the y-axis in the drawings) parallel to the incident direction of light.

The first rolling member 1151 may support the moving holder 115 with respect to the pivot plate 1132, and may enable pivoting of the moving holder 115 around the first axis (the x-axis in the drawings). The pivoting around the first axis may be driven by an interaction between the first OIS driving magnet 1163 and the first OIS driving coil 1164 (See FIG. 2). The second rolling member 1131 may support the pivot plate 1132 with respect to the housing 101, and may enable pivoting of the pivot plate 1132 together with the moving holder 115 around the second axis (the y-axis in the drawings). The pivoting around the second axis may be driven by an interaction between the second OIS driving magnet 1173 and the second OIS driving coil 1174 (See FIG. 2).

Referring to FIG. 4, the moving holder 115 may include a support surface 115a on which the reflective member 112 is seated. The support surface 115a may be a surface corresponding to a reflective surface 112a of the reflective member 112, and may be disposed to be inclined at a predetermined angle with respect to the incident direction of light.

The moving holder 115 may have an accommodating space 115b that, in an example, is an empty inner space below the support surface 115a, and accommodates the support arms 1135 and 1136. The support arms 1135 and 1136 may be extended to be disposed below the support surface 115a to be accommodated in the accommodating space 115b of the moving holder 115. Therefore, the support arms 1135 and 1136 may have portions overlapping the moving holder 115 along the incident direction of light.

The first rolling member 1151 may be disposed at one end corresponding to a free end of the support arms 1135 and 1136. The support arms 1135 and 1136 may have seating grooves 1135a and 1136a recessed in the optical axis direction at the one end. The first rolling member 1151 may be at least partially accommodated in the seating grooves 1135a and 1136a of the support arms 1135 and 1136. A pair of seating grooves 115c recessed in the optical axis direction may also be disposed at an inner wall forming the accommodating space 115b of the moving holder 115, and the first rolling member 1151 may be at least partially accommodated in the seating groove 115c of the moving holder 115. Therefore, the first rolling member 1151 may be disposed below the moving holder 115 along the incident direction of light.

In the folded module 110, in accordance with one or more embodiments, the first rolling member 1151 may be disposed close to a center of gravity CG of the moving holder 115 as the first rolling member 1151 is disposed at a lower end of the reflective member 112. That is, a distance I₁ from a pivot center (a center of the first rolling member) of one end of the support arm 1135 to the center of gravity CG may be shorter than a distance Iₒ from a pivot center (a center of an interval between the moving holder and the pivot plate) when the moving holder 115 is pivoted on a surface of the pivot plate 1132 to the center of gravity CG.

Therefore, it is possible to reduce a size of rotational moment generated by weights of the moving holder 115 and the reflective member 112 without increasing an additional size of the OIS driving portion. Additionally, when the first OIS driving magnet 1163 is spaced apart from a pivot center parallel to the first axis, a driving force necessary for rotation about the first axis may be reduced. Thus, power consumption necessary for OIS centering may be improved.

Referring to FIG. 5, in accordance with one or more embodiments, a distance d₁ between centers of the pair of seating grooves 115c of the moving holder 115 may be smaller than a size of a width w₁ along a direction (a direction of the x-axis in the drawings) of the first axis of the reflective member 112. Accordingly, a pair of first rolling members 1151 may be disposed below the reflective member 112 along the incident direction of light.

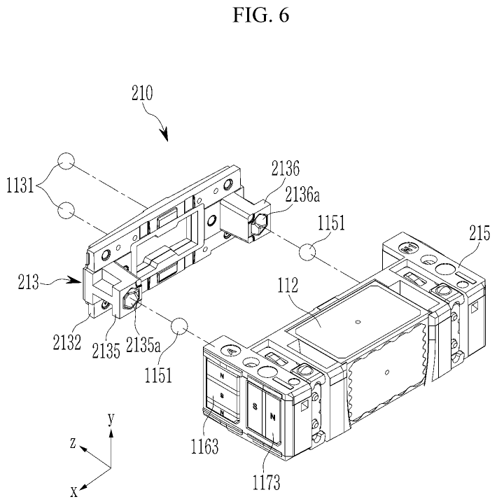

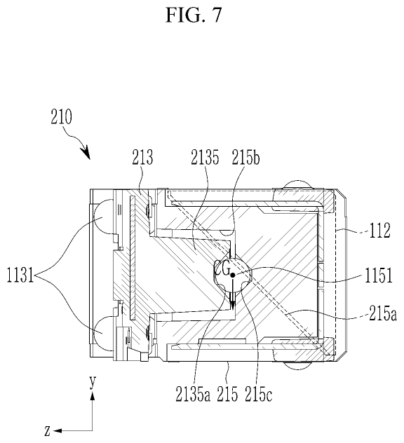

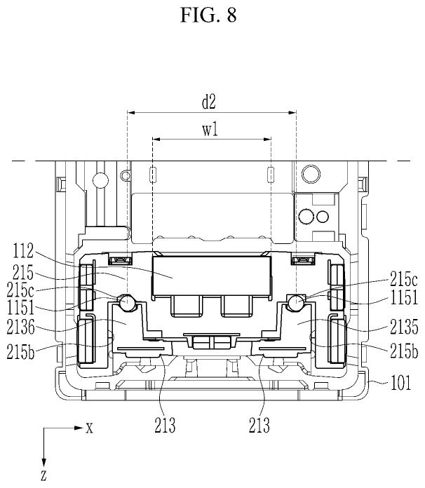

FIG. 6 is a partially exploded perspective view illustrating an example image stabilization module in accordance with one or more embodiments except for the housing, FIG. 7 is a cross-sectional view of the image stabilization module shown in FIG. 6 taken in the same manner as in FIG. 4, and FIG. 8 is a cross-sectional view of the image stabilization module shown in FIG. 6 taken in the same manner as in FIG. 5.

A folded module 210 of the example image stabilization module shown in FIGS. 6 to 8 includes a configuration substantially similar to the folded module 110 of the embodiment described with reference to FIGS. 3 to 5. However, there is a difference in some configurations of support arms 2135 and 2136 constituting a guide member 213 and a moving holder 215 corresponding to the support arms 2135 and 2136. Therefore, in the following description, a redundant description of the same configuration will be omitted, and a different configuration and an action and an effect of the different configuration will be described.

Referring to FIG. 6, the folded module 210 constituting the image stabilization module in accordance with one or more embodiments, includes the moving holder 215 on which the reflective member 112 is mounted, and the guide member 213 that supports the moving holder 215 to be movable with respect to the inner wall of the housing 101 of FIG. 1. The rolling members 1151 and 1131 may be respectively disposed between the moving holder 215 and the guide member 213 and between the guide member 213 and the inner wall of the housing 101.

The guide member 213 may include a pivot plate 2132 and the support arms 2135 and 2136 protruding from the pivot plate 2132. In a non-limited example, the support arms 2135 and 2136 protruding from the pivot plate 2132 may be formed as a pair. The pair of support arms 2135 and 2136 may be spaced apart from each other along the first axis (the x-axis in the drawings) that is perpendicular to the optical axis direction and is perpendicular to the incident direction of light.

Referring to FIG. 7, the moving holder 215 may include a support surface 215a on which the reflective member 112 is seated. The support surface 215a may be a surface corresponding to the reflective surface 112a of the reflective member 112, and may be disposed to be inclined at a predetermined angle with respect to the incident direction of light.

The moving holder 215 may have an accommodating space 215b that is an empty inner space at left and right sides of the support surface 215a and accommodates the support arms 2135 and 2136. The support arms 2135 and 2136 may be extended to be disposed at the left and right sides of the support surface 215a to be accommodated in the accommodating space 215b of the moving holder 215. Therefore, the support arms 2135 and 2136 may have portions overlapping the moving holder 215 along the incident direction of light.

The first rolling member 1151 may be disposed at one end corresponding to a free end of the support arms 2135 and 2136. The support arms 2135 and 2136 may have seating grooves 2135a and 2136a recessed in the optical axis direction at the one end. The first rolling member 1151 may be at least partially accommodated in the seating grooves 2135a and 2136a of the support arms 2135 and 2136. A pair of seating grooves 215c recessed in the optical axis direction may also be disposed at an inner wall forming the accommodating space 215b of the moving holder 215, and the first rolling member 1151 may be at least partially accommodated in the seating groove 215c of the moving holder 215. Therefore, the first rolling member 1151 may be disposed below the moving holder 215 along the incident direction of light.

Referring to FIG. 8, a distance d₂ between centers of the pair of seating grooves 215c of the moving holder 215 may be greater than the size of the width w₁ along the direction of the first axis of the reflective member 112. Accordingly, the pair of support arms 2135 and 2136 and the pair of first rolling members 1151 may be disposed at either side of the reflective member 112 in the direction of the first axis.

Referring to FIG. 7, in the folded module 210, in accordance with one or more embodiments, the first rolling member 1151 may be disposed at a center of gravity CG of the moving holder 215 as the first rolling member 1151 is disposed at left and right sides of the reflective member 112 below the moving holder 215 along the incident direction of light. Therefore, it is possible to reduce a size of rotational moment generated by weights of the moving holder 215 and the reflective member 112 without increasing an additional size of the OIS driving portion. Additionally, when the first OIS driving magnet 1163 is spaced apart from a pivot center parallel to the first axis, a driving force necessary for rotation about the first axis may be reduced. Thus, power consumption necessary for OIS centering may be improved.

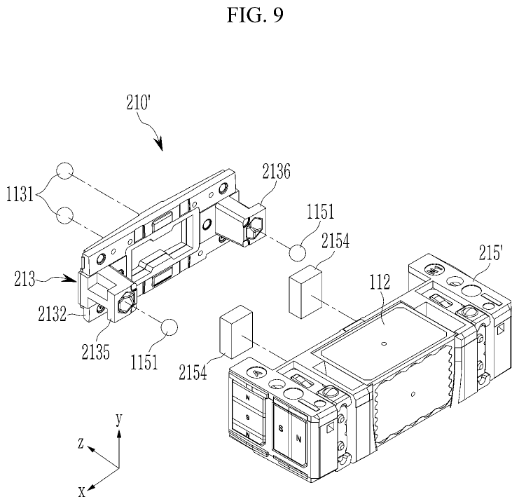

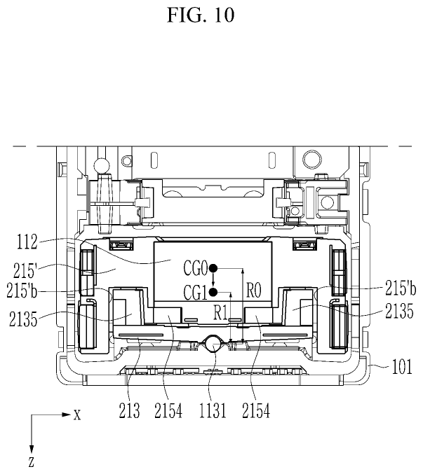

FIG. 9 is a partially exploded perspective view illustrating an image stabilization module, in accordance with one or more embodiments, except for the housing, and FIG. 10 is a cross-sectional view of the image stabilization module shown in FIG. 9 taken in the same manner as in FIG. 5.

Referring to FIG. 9, a folded module 210′ of the image stabilization module shown in FIGS. 9 and 10 includes a configuration substantially similar to the folded module 210 of the embodiment described with reference to FIGS. 6 to 8. Therefore, in the following description, redundant description of the same configuration will be omitted, and a different configuration and an action and an effect of the different configuration will be described.

Referring to FIG. 9, the folded module 210′ constituting the image stabilization module, in accordance with one or more embodiments, includes a moving holder 215′ on which the reflective member 112 is mounted, and the guide member 213 for supporting the moving holder 215′ to be movable with respect to the inner wall of the housing 101 of FIG. 1. The rolling members 1151 and 1131 may be respectively disposed between the moving holder 215′ and the guide member 213, and between the guide member 213 and the inner wall of the housing 101.

The guide member 213 may include the pivot plate 2132 and the support arms 2135 and 2136 protruding from the pivot plate 2132. In a non-limiting example, the support arms 2135 and 2136 protruding from the pivot plate 2132 may be formed as a pair.

The moving holder 215′ may have an accommodating space 215′b that is an empty inner space at left and right sides of the reflective member 112, and accommodates the support arms 2135 and 2136. The support arms 2135 and 2136 may be extended to be disposed at the left and right sides of the reflective member 112 to be accommodated in the accommodating space 215′b of the moving holder 215′. Accordingly, the support arms 2135 and 2136 may have portions overlapping the moving holder 215′ along the incident direction of light.

In the one or more examples, a pair of mass blocks 2154 fixed to the moving holder 215′ may be disposed within the accommodating space 215′b of the moving holder 215′. The pair of mass blocks 2154 may be disposed spaced apart from each other between the pair of support arms 2135 and 2136. The mass blocks 2154 may move a center of gravity CG of the moving holder 215′ at which the reflective member 112 is mounted toward the guide member 213. Therefore, a position of the center of gravity CG may be adjusted by fixing the mass blocks 2154 having an appropriate weight to the moving holder 215′.

The mass blocks 2154 that move an initial center of gravity CG₀ of the moving holder 215′ at which the reflective member 112 is mounted toward the guide member 213 may satisfy the following condition as indicated in Equation 1 below.

$${m}_{0} {gR}_{0} \geq {m}_{1} {gR}_{1} \qquad Equation 1$$

$$∴ Δ m \leq {m}_{0} \frac{Δ R}{{R}_{1}}$$

$$( {m}_{1} = {m}_{0} + Δ m , {R}_{1} = {R}_{0} - Δ R )$$

In Equation 1, m₀ is an initial mass of the moving holder equipped with the reflective member, m₁ is a mass of the moving holder equipped with the reflective member after the mass block is added, R₀ is a distance between an initial center of gravity CG₀ of the moving holder equipped with the reflective member and a pivot center of the second OIS driving portion, R₁ is a distance between a center of gravity Ca of the moving holder equipped with the reflective member after the mass block is added and a pivot center of the second OIS driving portion, Δm is a mass increase amount of the moving holder equipped with the reflective member, and ΔR is a shift amount of the center of gravity.

According to the folded module 210′, in accordance with one or more embodiments, when the first OIS driving magnet 1163 is spaced apart from a pivot center of the first OIS driving portion parallel to the first axis, a driving force desired for rotation about the first axis may be reduced. Thus, power consumption necessary for OIS centering may be improved. Additionally, the mass block 2154 may be added so that a distance between the pivot center of the second OIS driving portion parallel to the second axis (the y-axis in the drawings) and the center of gravity Ca is reduced. Thus, a rotational moment due to gravity may be reduced so that the power consumption necessary for the OIS centering is improved. In this example, a mass increase amount may be adjusted so that an amount of rotational moment after the center of gravity is changed is reduced.

While this disclosure includes specific examples, it will be apparent to one of ordinary skill in the art, after an understanding of the disclosure of this application, that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An optical image stabilization module, comprising:
a housing having an inner space;
a moving holder, accommodated in the inner space, and including a reflective member configured to receive light incident from outside, change a path of the received light, and transmit the light along an optical axis direction;
a guide member including a pivot plate interposed between an inner wall of the housing and the moving holder and support arms that protrude from the pivot plate to extend along the optical axis direction; and
a first rolling member disposed at one end of the support arms.

2. The optical image stabilization module of claim 1, wherein the moving holder includes a support surface at which the reflective member is seated to correspond to a reflective surface of the reflective member, and the support arms are extended to be disposed below the support surface.

3. The optical image stabilization module of claim 1, wherein the support arms include a pair of support arms, and the pair of support arms are spaced apart from each other along a first axis that is perpendicular to the optical axis direction and perpendicular to an incident direction of the light.

4. The optical image stabilization module of claim 3, wherein the first rolling member includes a pair of first rolling members, and the pair of first rolling members are disposed at a first side and a second side of the reflective member in a direction of the first axis perpendicular to the optical axis direction.

5. The optical image stabilization module of claim 3, wherein the moving holder has an accommodating space that is an empty inner space and accommodates the support arms, an inner wall forming the accommodating space has a pair of seating grooves in which the first rolling member is at least partially accommodated, and the pair of seating grooves are spaced apart from each other along the first axis perpendicular to the optical axis direction.

6. The optical image stabilization module of claim 5, wherein a distance between centers of the pair of seating grooves of the moving holder is smaller than a size of a width of the reflective member in a direction of the first axis perpendicular to the optical axis direction.

7. The optical image stabilization module of claim 5, wherein a distance between centers of the pair of seating grooves of the moving holder is greater than a size of a width of the reflective member in a direction of the first axis perpendicular to the optical axis direction.

8. The optical image stabilization module of claim 5, further comprising mass blocks that are disposed between the pair of support arms within the accommodating space, and are fixed to the moving holder.

9. The optical image stabilization module of claim 3, wherein the first rolling member disposed at a first end of the pair of support arms includes a plurality of first ball units arranged along the first axis perpendicular to the optical axis direction.

10. The optical image stabilization module of claim 9, wherein a second rolling member is disposed between the pivot plate and an inner surface of the housing, and the second rolling member includes a plurality of ball units disposed along a second axis parallel to the incident direction of light.

11. A camera module, comprising:
a housing having an inner space;
an optical image stabilization module, accommodated in the inner space, and movably supported at an inner wall of the housing, and including a reflective member configured to receive light incident from outside, change a path of the received light, and transmit the light along an optical axis direction; and
a lens module that includes a lens barrel including a plurality of lenses disposed in the optical axis direction so that light reflected by the reflective member passes through the lens barrel,
wherein the image stabilization module comprises:
a guide member including a pivot plate interposed between the inner wall of the housing and the moving holder, and support arms that protrude from the pivot plate to extend along the optical axis direction; and
a first rolling member disposed at one end of the support arm.

12. The camera module of claim 11, wherein the moving holder includes a support surface at which the reflective member is seated to correspond to a reflective surface of the reflective member, and the support arms are extended to be disposed below the support surface.

13. The camera module of claim 11, wherein the support arms include a pair of support arms, and the pair of support arms are spaced apart from each other along a first axis that is perpendicular to the optical axis direction and perpendicular to an incident direction of the light.

14. The camera module of claim 13, wherein the first rolling member includes a pair of first rolling members, and the pair of first rolling members are disposed at a first side and a second side of the reflective member in a direction of the first axis perpendicular to the optical axis direction.

15. The camera module of claim 13, wherein the moving holder has an accommodating space that is an empty inner space and accommodates the support arms, an inner wall forming the accommodating space has a pair of seating grooves in which the first rolling member is at least partially accommodated, and the pair of seating grooves are spaced apart from each other along the first axis.

16. The camera module of claim 15, further comprising mass blocks that are disposed between the pair of support arms within the accommodating space to be fixed to the moving holder.

17. An electronic device, comprising:
a folded module, comprising:
a moving holder, including a reflective member, and configured to rotate around an axis perpendicular to an optical axis direction;
a guide member configured to support the moving holder, and including a pivot plate and support arms protruding from the pivot plate, and configured to extend toward the moving holder; and
rolling members disposed on one end of the support arms between the support arms and the moving holder.

18. The electronic device of claim 17, wherein the support arms and the rolling members are spaced apart in a direction perpendicular to the optical axis direction.

19. The electronic device of claim 17, wherein the rolling members are disposed at a center of gravity of the moving holder at a lower end of the reflective member.
